(19) United States
(12) Patent Application Publication
(10) Pub. No.: US 2006/0272896 A1
(43) Pub. Date: Dec. 7, 2006

(54) Mobile roof loading system

(76) Inventor: David E. Rajewski, Spokane, WA (US)

Correspondence Address: WELLS ST. JOHN P.S., 601 W. FIRST AVENUE, SUITE 1300, SPOKANE, WA, 99201, US

(21) Appl. No.: 11/145,546

(22) Filed: Jun. 3, 2005

(51) Int. Cl. E06C 5/00

(52) U.S. Cl. 182/127

(57) ABSTRACT

A mobile roof loading system is provided for operatively attaching to a roof of a vehicle such as a trailer, to provide access to the roof, and hands-free access to the roof in some embodiments. The system may for instance include a stairway body configured for pivotal attachment to a vehicle, the stairway body including a plurality of steps and a step support, the stairway body further having a contracted configuration and an expanded configuration, such that in the contracted configuration the stairway body is retained adjacent the vehicle generally between the roof of the vehicle and a bottom side of the vehicle; and in the expanded configuration the stairway body forms a stairway path from the roof to nearby ground at a stairway angle such as to provide a desired stairway path.

### TECHNICAL FIELD

This invention pertains to a mobile roof loading system, and more particularly to such a system or stairway system which may be utilized for improved access to the roof and for loading items on to the roof of a vehicle.

### BACKGROUND OF THE INVENTION

In order to provide more storage, the makers of vehicles such as trucks, trailers, campers, recreational vehicles and the like, have been adding storage areas, racks and other means to provide for additional storage on the roof of the vehicles. However the roofs are typically elevated beyond reach and the ladders provided or available are too vertically oriented or require one or two hands to maintain one's position on the ladder and/or to climb the ladder. This situation makes it difficult, impractical or impossible to place heavier or awkward items on the roof for storage that require two free hands to lift and place.

It is therefore an object of embodiments of this invention to provide an improved stairway system for use in accessing the roof of vehicles, trucks, trailers and recreational vehicles.

It is a still further object of some embodiments of this invention to provide a hands-free or near hands-free stairway system which provides access to the roof of vehicles, trucks, campers, trailers and recreational vehicles.

The above needs are fulfilled as will be understood from the following description which, taken with the accompanying drawings and appended claims, describe the best mode currently known for carrying out the present invention.

### BRIEF DESCRIPTION OF THE DRAWINGS

Preferred embodiments of the invention are described below with reference to the following accompanying drawings.

FIG. 1 is a side view of one embodiment of the invention in the expanded configuration;

FIG. 2 is a perspective view of an embodiment of the invention in a contracted configuration, with the hand rails still extended;

FIG. 3 is a perspective view of an embodiment of the invention in a contracted configuration, and with the hand rails contracted or folded inwardly;

FIG. 4 is an elevation view of a vehicle, namely a travel and horse trailer, with an embodiment of the invention in an extended configuration providing loading access to the roof;

FIG. 5 is an elevation view of a vehicle, namely a camper on a truck, with an embodiment of the invention in an extended configuration providing loading access to the roof;

FIG. 6 is a perspective view of an embodiment of the invention in an expanded configuration with the second body section in a slidable relationship to the first body section;

FIG. 7 is a partial closeup perspective view of the embodiment of the invention shown in FIG. 6;

FIG. 8 is a partial closeup perspective view of an embodiment of the upper portion of a first body section of the stairway as pivotally attached to a vehicle;

FIG. 9 is a partial closeup side view of an embodiment of the invention, illustrating one of many possible configurations which may be utilized to provide a slidable relationship between a first body section and a second body section;

FIG. 10 is a partial close up perspective view of an embodiment of the invention, in which the second body section is slidable with respect to the first body section;

FIG. 11 is a side elevation view of an embodiment of the invention, illustrating an alternative configuration of the invention wherein the second body section is pivotally attached relative to the first body section; and

FIG. 12 is a side view of another embodiment or example of how first body section may be alternatively attached to or supported by a mount structure or vehicle.

### DETAILED DESCRIPTION OF THE PREFERRED EMBODIMENTS

Fasteners, materials, drive mechanisms, control circuitry, manufacturing and other means and components utilized to make and implement this invention are known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

The term pivotal attachment as used herein in connection with the pivotal attachment of the stairway body to the vehicle, trailer, recreational vehicle or truck, or in connection with the pivotal attachment of the second body section to the first body section, is not limted to a direct pivotal or operative attachment, but also to indirect pivotal attachments, so long as part of the item pivotally attached pivots or rotates relative to the member to which it is said or claimed to be pivotally attached to.

The term “vehicle” as used herein is to be construed broadly to cover such items as vehicles, trailers, recreational vehicles, trucks, campers on trucks, wheeled items, or the like, whether including an engine or not, or whether intended to be pulled by another vehicle with an engine.

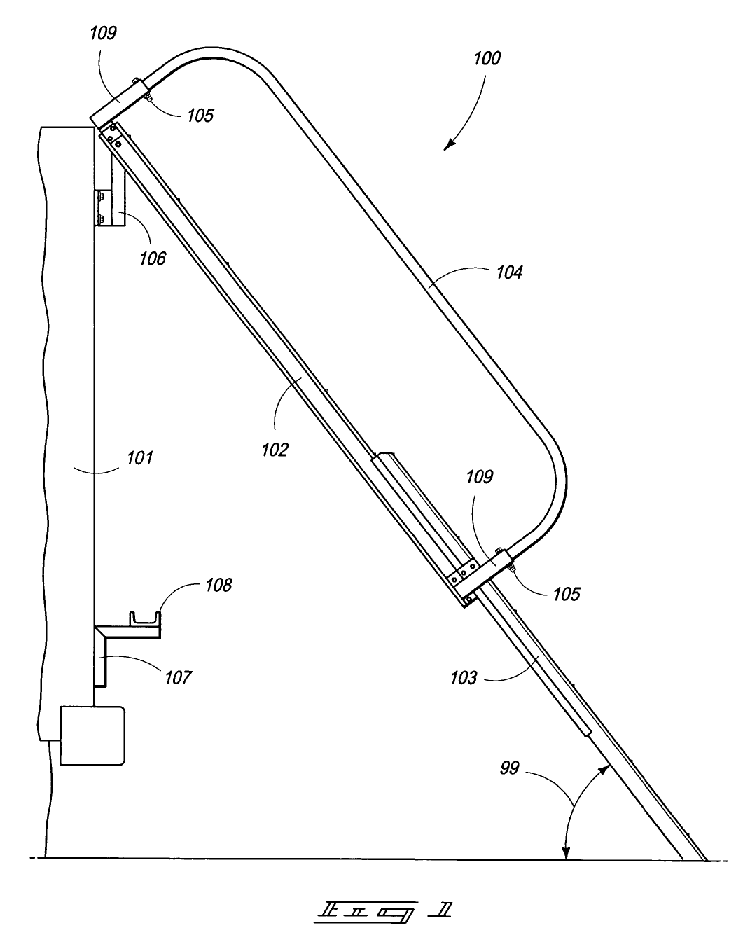

FIG. 1 is a side view of one embodiment of the invention in the expanded configuration, illustrating a stairway system 100 pivotally attached to a vehicle 101. FIG. 1 illustrates a roof loading system or mobile-based stairway system 100 pivotally attached to vehicle 101 via pivot mount structure 106. The stairway body is comprised of first body section 102 and second body section 103, with the stairway system shown in FIG. 1 being in the expanded configuration.

The stairway body forms a stairway angle 99 with respect to the ground as shown, and this angle may be very different in contemplation and scope of this invention, with no one particular angle being required to practice this invention. It is preferred, however, that the angle being sufficient to provide hands-free use of the stairway when carrying objects for loading on vehicle 101.

Hand rail mounts 109 provide a structure for pivotal attachment of hand rail 104 to hand rail mounts via hand rail bolts 105, which provide an axis of rotation for hand rail 104 to be rotated downward to first body section 102 when being placed in the contracted configuration.

Stairway mount bracket 107 is attached to vehicle 101 and provides after 108 provides for easy securement of the roof loading system in the contracted position.

As will be shown in later figures, second body section 103 is slidably mounted on first body section 102 to allow the sliding of second body section 103 further overlapping first body section 102 to facilitate the storage and securement of the stairway system while the vehicle is traveling.

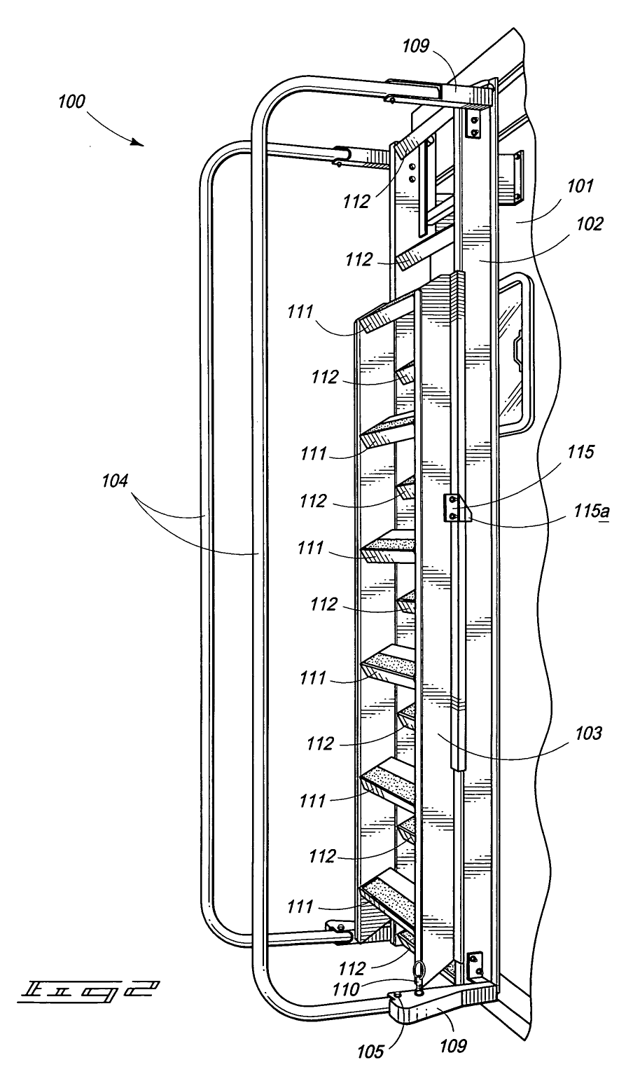

FIG. 2 is a perspective view of an embodiment of the invention in a contracted configuration, with the hand rails still extended. FIG. 2 illustrates the embodiment of the invention shown in FIG. 1, shown in the contracted configuration, which is the configuration desired to travel. Although it is preferred that the stairway system be utilized in the expanded configuration, FIG. 2 illustrates how the stairway system may also be used in the contracted configuration, which is more like a traditional ladder provided on vehicles.

FIG. 2 illustrates first body section 102, second body section 103, first body section steps 112, second body section steps 111, hand rails 104, vehicle 101, hand rail mounts 109, and cotter pin 110, which extends to hand rail mount 109 and through hand rail 104 in order to secure the hand rail 104 in the extended or usable position or configuration.

Roof loading system 100 shown in FIG. 2, as will be appreciated by those of ordinary skill in the art, can be mounted to vehicle 101 in any one of a number of different ways within a contemplation of this invention. For instance, it may be nearly secured and mounted in the contracted configuration, but not necessarily be pivotally attached at the upper portion. Instead, a hook or other attachment means may be utilized to secure it to the vehicle when in the expanded configuration for use. It is, however, preferred that it be pivotally attached for ease of use.

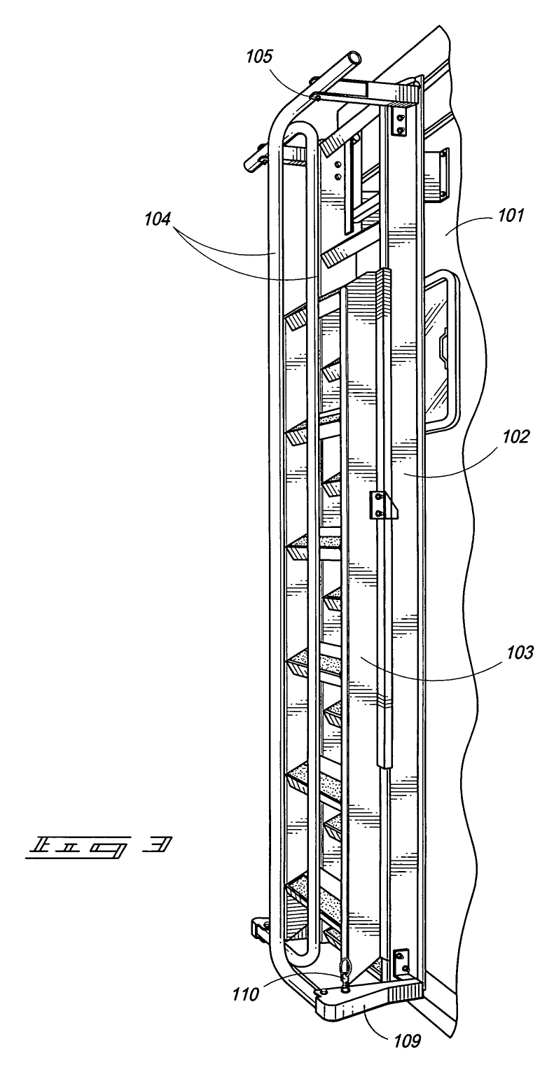

FIG. 3 is a perspective view of an embodiment of the invention in a contracted configuration, with the hand rails contracted or folded inwardly. FIG. 3 illustrates the embodiment of the invention shown in FIG. 1 shown in the contracted configuration, and further illustrating the hand rails 104 in the contracted position, having been pivoted inward about bolt 105 which is the axis of rotation.

FIG. 3 further illustrates vehicle 101, first body section 102, second body section 103, hand rail mount 109 and cotter pin 110. For purposes of this invention, the terms “operatively attached” or “attached” is used in connection with the attachment of the roof loading system or the stairway body to the vehicle, it is intended to include any mechanism or means by which the stairway body is sufficiently secured to allow loading. This may be by hook or by other attachment means, it need not be pivotally attached as shown in the preferred embodiment.

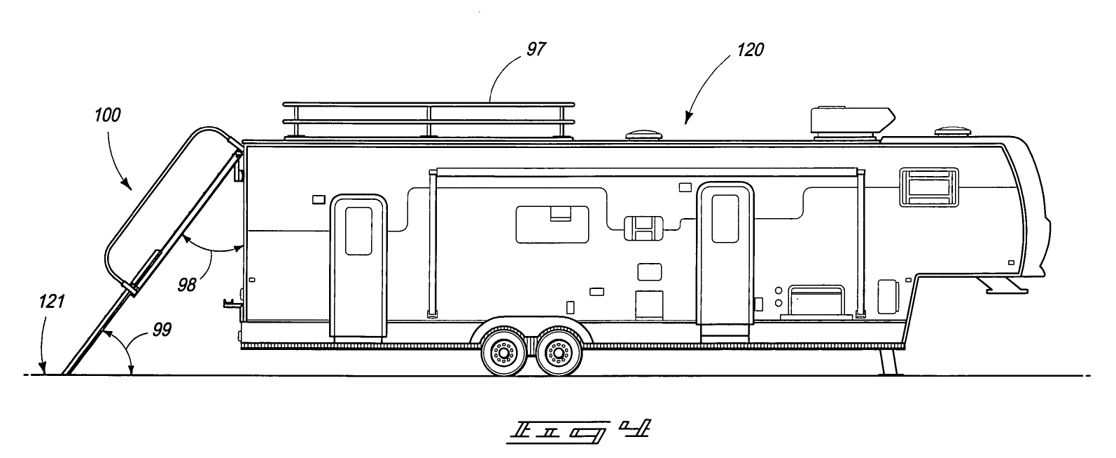

FIG. 4 is an elevation view of a vehicle, namely a travel and horse trailer, with an embodiment of the invention in an extended configuration providing loading access to the roof.

FIG. 4 illustrates a vehicle with a roof loading system or stairway pivotally attached at the rear of the vehicle and shown in an expanded configuration in FIG. 4. The stairway system 100 is shown expanded for loading to a roof storage area defined by rails 97, and at a ground angle 99 and an angle 98 with respect to the vehicle. In the expanded configuration the stairway system is resting on the ground 121 for support on its lower end.

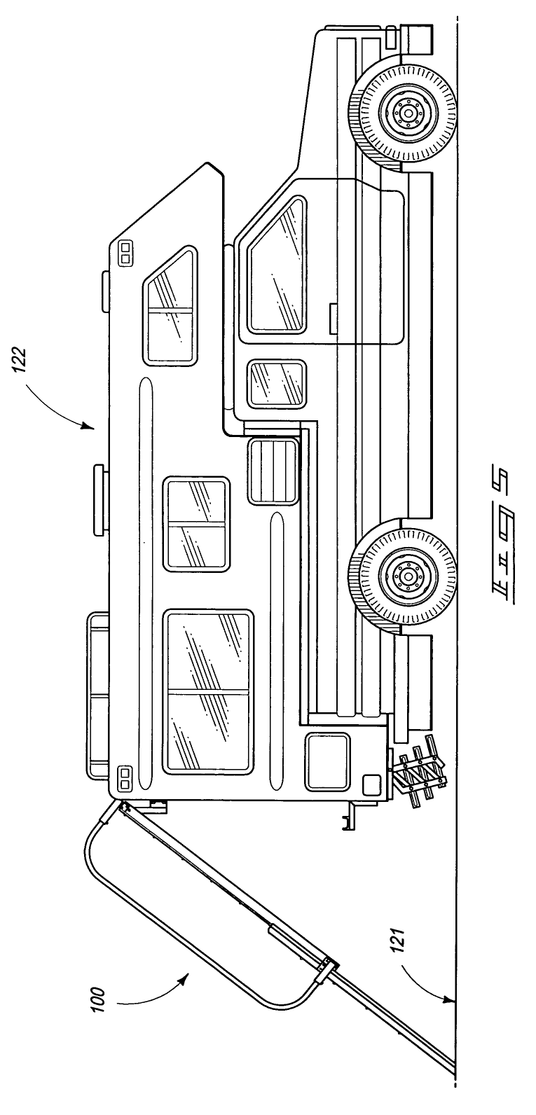

FIG. 5 is an elevation view of a vehicle, namely a camper on a truck, with an embodiment of the invention in an extended configuration providing loading access to the roof.

FIG. 5 shows another vehicle, namely a camper configuration 122 mounted on a pickup truck, with a stairway system, a roof loading system 100 pivotally mounted to the vehicle and in an expanded configuration resting on ground 121.

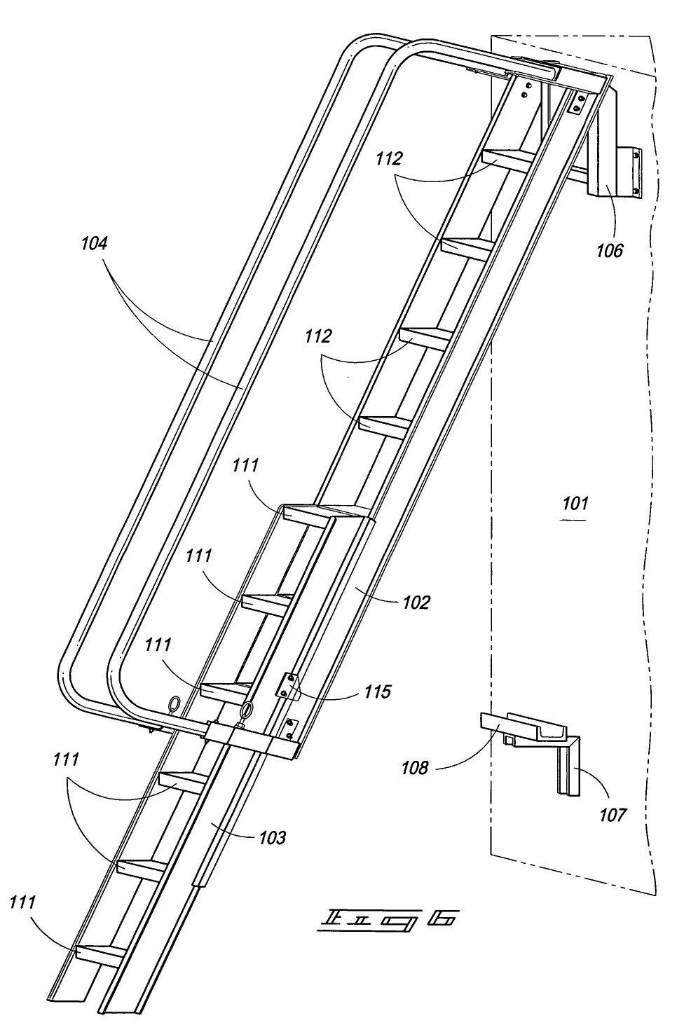

FIG. 6 is a perspective view of an embodiment of the invention in an expanded configuration with the second body section in a slidable relationship to the first body section.

FIG. 6 is a perspective view of an embodiment of the invention in an expanded configuration, showing first body section 102, second body section 103, vehicle 101, hand rails 104, first section steps 112 and second section steps 111.

The slide guide 115 is mounted to second body section 103 and overlaps and guides second body section 103 with respect to first body section 102 to provide relatively aligned sliding of second body section 103. There is no one particular device or mechanism required by this invention to transform from the contracted configuration to the expanded configuration, as any one of a number of such devices may be utilized. For instance, while sliding is shown as the preferred embodiment, a pivotal attachment or relationship may also be utilized, as illustrated in later figures. Another alternative is an interlocking feature where second body section 103 may be completely separate and independent, attached in an overlapping way for the contracted configuration, and separately lifted and reattached for the expanded configuration all within a contemplation of the scope of this invention.

FIG. 6 further illustrates stairway mount bracket 107 and adapter 108 mounted to vehicle 101, and pivot mount structure 106 mounted to vehicle 101.

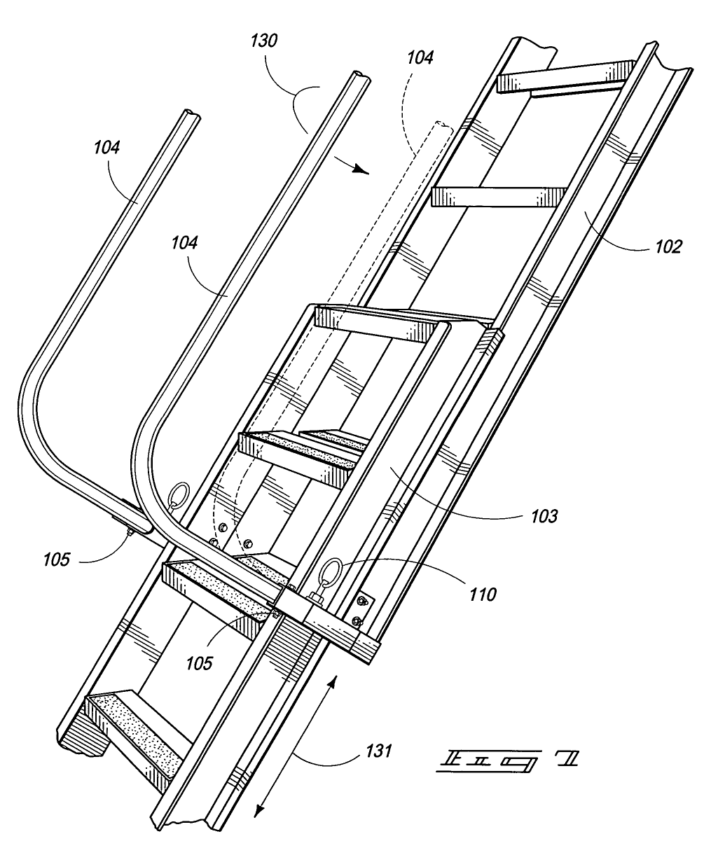

FIG. 7 is a partial closeup perspective view of the embodiment of the invention shown in FIG. 6

FIG. 7 is a partial close up illustrating first body section 102, second body section 103, hand rails 104, cotter pin 110 and bolts 105, which provide an axis for rotation for hand rails 104 to be rotated to the inward position (shown in shaded lines) once cotter pin 110 is released. The inward position, as shown in prior figures, provides a better travel configuration. Arrow 131 illustrates how second body section 103 slides relative to first body section 102.

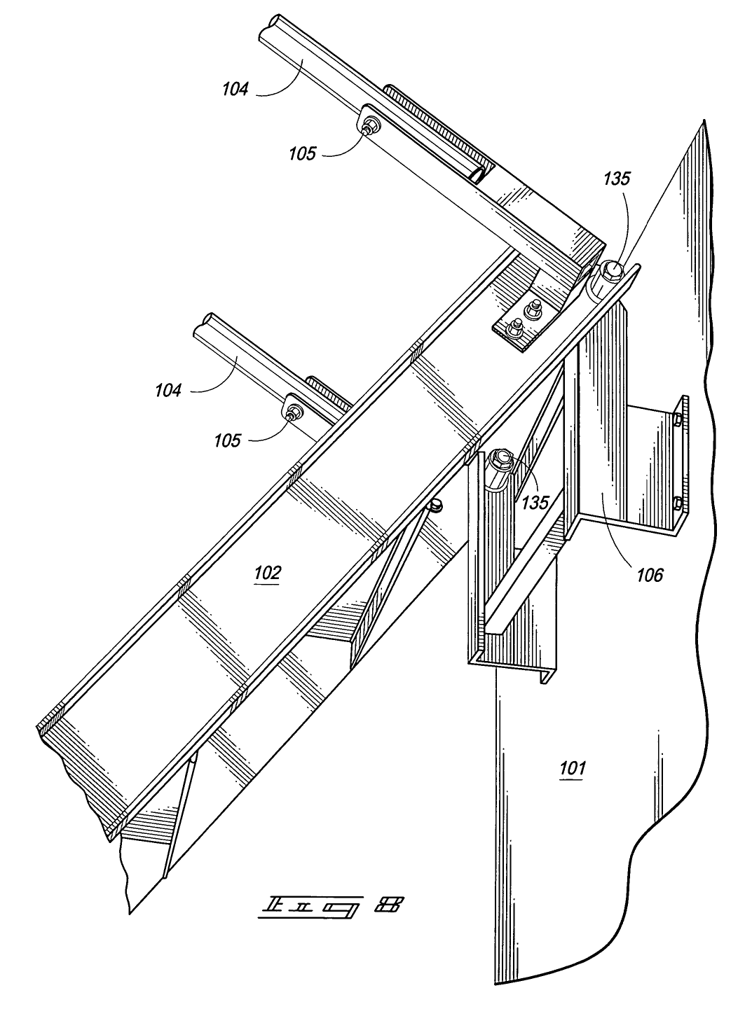

FIG. 8 is a partial closeup perspective view of an embodiment of the upper portion of a first body section of the stairway as pivotally attached to a vehicle.

FIG. 8 is a close up perspective showing one embodiment of a connection of the stairway body to the vehicle. FIG. 8 illustrates a pivotal attachment utilizing bolts 135 through pivot mount structure 106 which is attached to vehicle 101. This pivotal attachment allows first body section 102 to be pivoted about bolts 135, which provide access rotation to allow the stairway body to be placed in an expanded configuration.

FIG. 8 further illustrates bolts 105 about which hand rails 104 pivot depending on the needs for loading and hand rail support. Although hand rails are shown in embodiments of this invention, they are not required to practice all embodiments of this invention since the stairway or roof loading system also provides a hands-free way of loading.

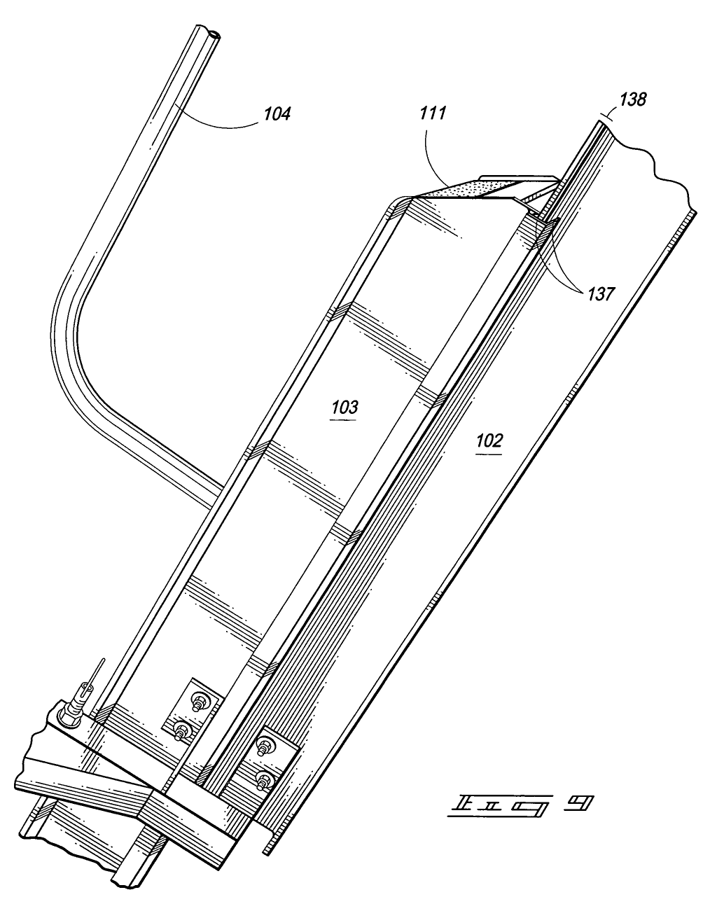

FIG. 9 is a partial closeup side view of an embodiment of the invention, illustrating one of many possible configurations which may be utilized to provide a slidable relationship between a first body section and a second body section.

FIG. 9, illustrates another one of a number of other ways to provide the sliding relationship between first body section 102 and second body section 103 via channel number 137, and second body section 103 and phalange or protrusion 138 on first body section 102, thereby providing the guiding for the relative sliding of second body section 103 relative to first body section 102. Hand rail 104 is also shown in FIG. 9.

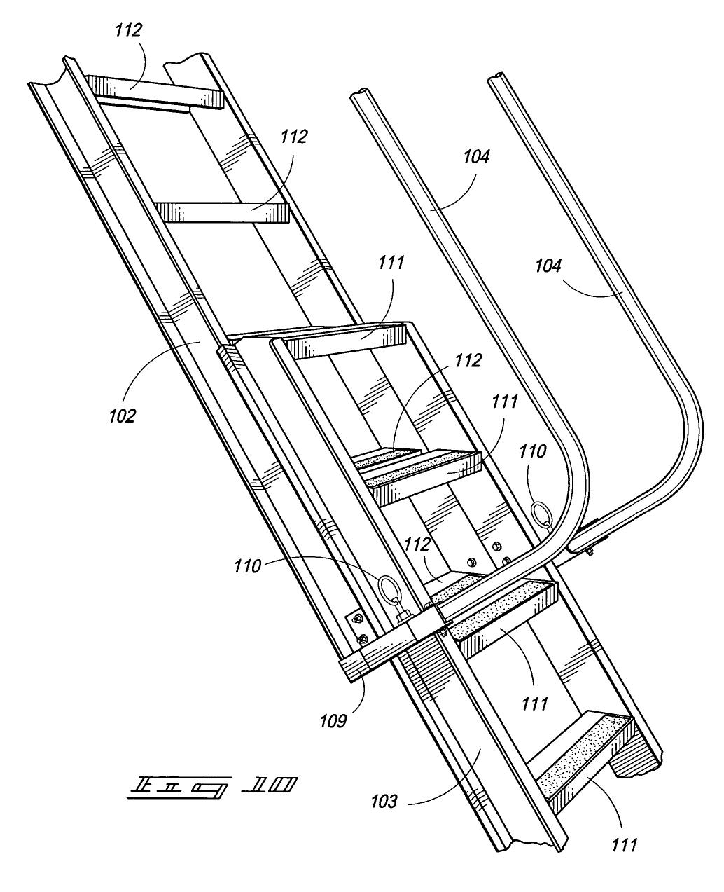

FIG. 10 is a partial close up perspective view of an embodiment of the invention, in which the second body section is slidable with respect to the first body section

FIG. 10 is a perspective view of an embodiment in the expanded configuration, illustrating first body section 102, second body section 103, first body section steps 112 and second body section steps 111, hand rails 104 and cotter pins 110. Hand rail mounts 109 are shown supporting hand rails 104 as described with respect to other figures.

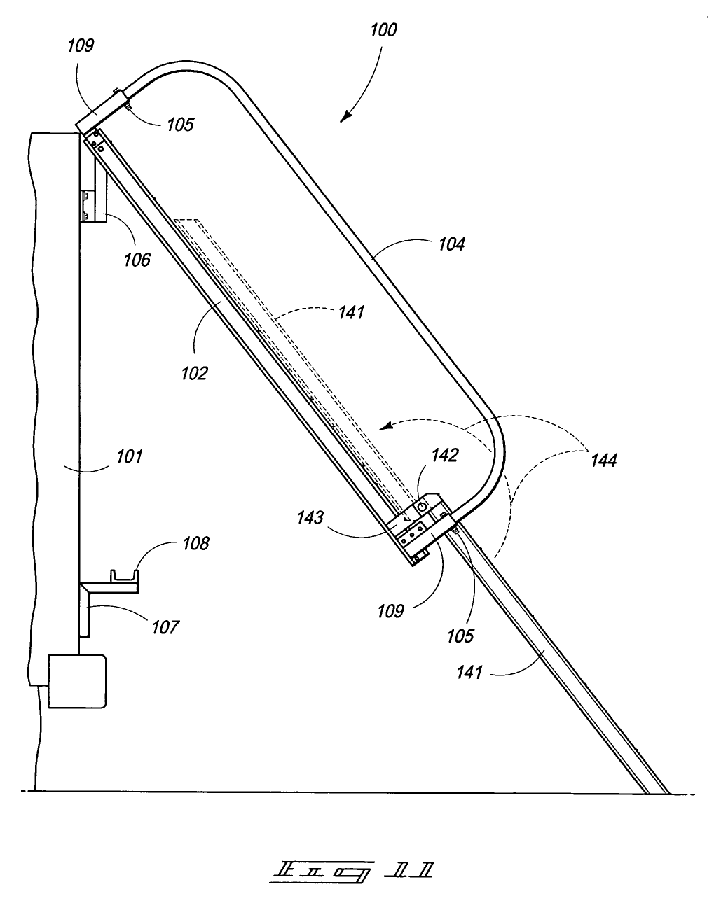

FIG. 11 is a side elevation view of an embodiment of the invention, illustrating an alternative configuration of the invention wherein the second body section is pivotally attached relative to the first body section.

FIG. 11 illustrates one of alternative embodiments for the relative attachment of first body section 102 and second body section 141, wherein second body section 141 is pivotally attached to first body section 102 via attachment structure 143 and pivot bolt 142, which provides an axis of rotation as shown by arrow 144.

The roof loading system or stairway system 100 illustrated in FIG. 11 is in the expanded position but shadow lines 141 show it pivoted upward in the contracted position. Once in the contracted position, the stairway body would be pivoted towards vehicle 101 and secured into adapter 108 on stairway mount bracket 107, which is attached to vehicle 101. All other like numbered figures are described in reference with respect to other figures and will not be repeated herein.

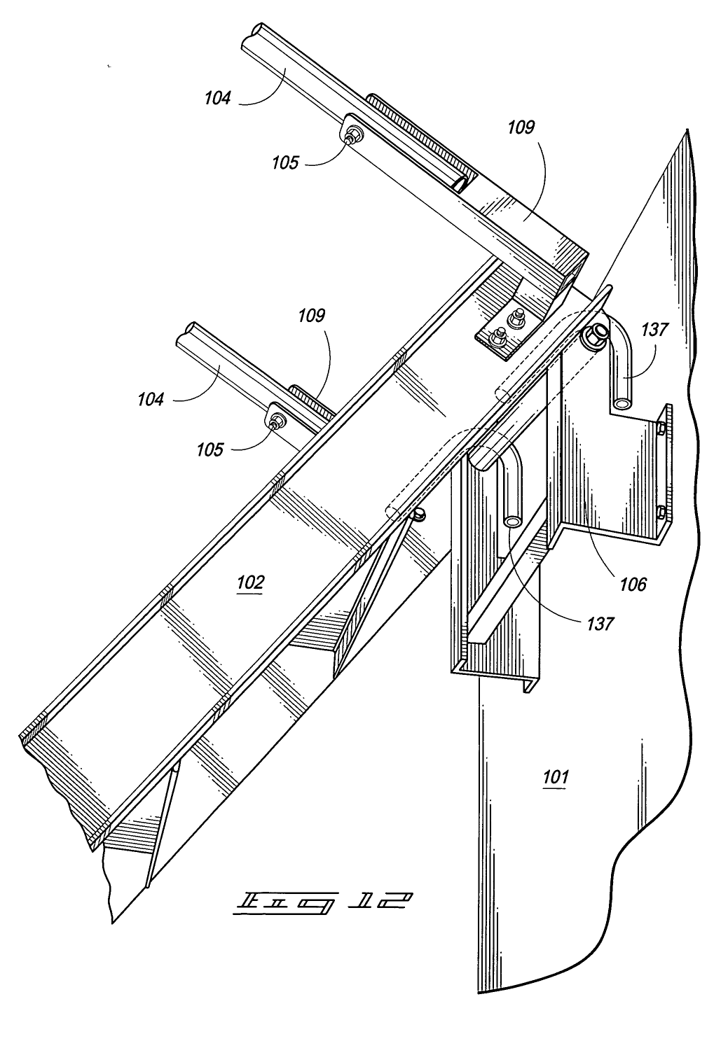

FIG. 12 is a side perspective view of another embodiment or example of how first body section 102 may be alternatively attached to or supported by a mount structure or vehicle 101. Attachment arm 137 is a bent arm attached to first body section 102 and which interacts with pivot mounts structure 106 to support the stairway body and sufficiently secure it in position to provide for roof loading as contemplated by this invention. It will be appreciated by those of ordinary skill in the art that attachment arm 137 need not interact with a bracket 106 but may also be configured to interact with another part of the vehicle 101, such as overlapping it over the top of the roof of vehicle 101 in a secure way, with no one particular way of attaching the stairway body being required to practice this invention.

FIG. 12 further illustrates hand rails 104 pivotally mounted via bolts 105 to hand rail mounts 109.

As will be appreciated by those of reasonable skill in the art, there are numerous embodiments to this invention, and variations of elements and components which may be used, all within the scope of this invention.

In one embodiment for example a stairway system is provided for operatively attaching to a roof of a vehicle to provide access to the roof, the stairway system comprising: a stairway body configured for operative attachment to a vehicle, the stairway body including a plurality of steps and a step support, the stairway body further having a contracted configuration and an expanded configuration such that: in the contracted configuration the stairway body is retained adjacent the vehicle generally between the roof of the vehicle and a bottom side of the vehicle; and in the expanded configuration the stairway body forms a stairway path from the roof to nearby ground at a stairway angle such as to provide a desired stairway path.

In further embodiments from that recited in the preceding paragraph, the stairway system may be provided: further wherein the stairway body is configured for pivotal attachment to the vehicle at or adjacent an upper end of the stairway body; further wherein the stairway body is comprised of a first body section and a second body section, and further wherein the first body section is configured for pivotal attachment to the vehicle body and the second body section is pivotally attached to the first body section such that the second body section is pivoted away from the first body section in reconfiguring the stairway body from the contracted configuration to the expanded configuration; and/or still further wherein the stairway body is comprised of a first body section and a second body section, and further wherein the first body section is configured for pivotal attachment to the vehicle body and the second body section is slidably attached relative to the first body section, such that the second body section is configured to be slid away from the first body section in reconfiguring the stairway body from the contracted configuration to the expanded configuration.

As stated above, it will also be appreciated that the vehicle may be a travel trailer, or a recreational vehicle, or any one of a number of others.

In some embodiments of the stairway system, at least one hand rail mounted to the stairway body, and still further, the at least one hand rail may be pivotally mounted to the stairway body such that when the stairway body is in the contracted position, the at least one hand rail is pivoted near the stairway body, and when the stairway body is in the expanded position, the at least one hand rail is pivoted away from the stairway body and configured for use as a hand rail. Even though a handrail may be used in embodiments, the stairway angle may also preferably be configured to allow hands-free use of the stairway.

In yet another embodiment of the invention, a hands-free stairway system for operatively attaching to a roof of a vehicle to provide access to the roof, the stairway system comprising: a stairway body configured for operative attachment to a vehicle, the stairway body including a plurality of steps and a step support, the stairway body further having a contracted configuration and an expanded configuration such that: in the contracted configuration the stairway body is retained adjacent the vehicle generally between the roof of the vehicle and a bottom side of the vehicle; in the expanded configuration the stairway body forms a stairway path from the roof to nearby ground at a stairway angle which provides a desired stairway path configured for hands-free usage.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A stairway system for operatively attaching to a roof of a vehicle to provide access to the roof, the stairway system comprising:
a stairway body configured for operative attachment to a vehicle, the stairway body including a plurality of steps and a step support,
the stairway body further having a contracted configuration and an expanded configuration such that:
in the contracted configuration the stairway body is retained adjacent the vehicle generally between the roof of the vehicle and a bottom side of the vehicle; and
in the expanded configuration the stairway body forms a stairway path from the roof to nearby ground at a stairway angle such as to provide a desired stairway path.

2. A stairway system as recited in claim 1, and further wherein the stairway body is configured for pivotal attachment to the vehicle at or adjacent an upper end of the stairway body.

3. A stairway system as recited in claim 1, and wherein the stairway body is comprised of a first body section and a second body section, and further wherein the first body section is configured for pivotal attachment to the vehicle body and the second body section is pivotally attached to the first body section such that the second body section is pivoted away from the first body section in reconfiguring the stairway body from the contracted configuration to the expanded configuration.

4. A stairway system as recited in claim 1, and wherein the stairway body is comprised of a first body section and a second body section, and further wherein the first body section is configured for pivotal attachment to the vehicle body and the second body section is slidably attached relative to the first body section, such that the second body section is configured to be slid away from the first body section in reconfiguring the stairway body from the contracted configuration to the expanded configuration.

5. A stairway system as recited in claim 1, and further wherein the vehicle is a travel trailer.

6. A stairway system as recited in claim 1, and further wherein the vehicle is a recreational vehicle.

7. A stairway system as recited in claim 3, and further comprising at least one hand rail mounted to the stairway body.

8. A stairway system as recited in claim 7, and further wherein the at least one hand rail is pivotally mounted to the stairway body such that when the stairway body is in the contracted position, the at least one hand rail is pivoted near the stairway body, and when the stairway body is in the expanded position, the at least one hand rail is pivoted away from the stairway body and configured for use as a hand rail.

9. A stairway system as recited in claim 1, and further wherein the stairway angle is sufficiently small that a user may utilize the stairway without any free hands when the stairway is in the expanded configuration.

10. A stairway system as recited in claim 1, and further wherein when the stairway is in the contracted configuration, it is substantially vertical and is configured for use to access the roof of the vehicle.

11. A hands-free stairway system for operatively attaching to a roof of a vehicle to provide access to the roof, the stairway system comprising:
a stairway body configured for operative attachment to a vehicle, the stairway body including a plurality of steps and a step support,
the stairway body further having a contracted configuration and an expanded configuration such that:
in the contracted configuration the stairway body is retained adjacent the vehicle generally between the roof of the vehicle and a bottom side of the vehicle;
in the expanded configuration the stairway body forms a stairway path from the roof to nearby ground at a stairway angle which provides a desired stairway path configured for hands-free usage.
